(19) United States
(12) Patent Application Publication
(10) Pub. No.: US 2025/0013306 A1
(43) Pub. Date: Jan. 9, 2025

(54) VIBRATION PERCEPTION POSITION CONTROL APPARATUS, VIBRATION PERCEPTION POSITION CONTROL METHOD, AND VIBRATION PERCEPTION POSITION CONTROL PROGRAM

(71) Applicant: NIPPON TELEGRAPH AND TELEPHONE CORPORATION, Tokyo (JP)

(72) Inventors: Toki TAKEDA, Tokyo (JP); Arinobu NIIJIMA, Tokyo (JP); Ryosuke AOKI, Tokyo (JP); Shinji MIYAHARA, Tokyo (JP)

(73) Assignee: NIPPON TELEGRAPH AND TELEPHONE CORPORATION, Tokyo (JP)

(21) Appl. No.: 18/708,237

(22) PCT Filed: Dec. 14, 2021
(86) PCT No.: PCT/JP2021/046038

§ 371 Date: May 8, 2024

(51) Int. Cl. G06F 3/01; G06F 3/16

(52) U.S. Cl. CPC G06F 3/016; G06F 3/165

(57) ABSTRACT

A vibration perception position control device includes a sound image localization setting unit, a vibration signal generation unit, a synchronization control unit, a guidance control unit, a sound control unit, and a vibration control unit. The sound image localization setting unit performs setting for localizing a sound image in a drive signal of a sound device on the basis of information indicating a direction of a sound source of each sound included in sound data. The vibration signal generation unit generates a vibration signal on the basis of information indicating vibration of a vibration device that applies vibration to a palm surface of a user. The synchronization control unit performs control to synchronize timings at which sound and vibration are generated. The guidance control unit controls presentation of guidance information for guiding the orientation and angle of the palm surface.

### TECHNICAL FIELD

One aspect of the present invention relates to a vibration perception position control device, a vibration perception position control method, and a vibration perception position control program.

### BACKGROUND ART

An existing device such as a smartphone or a game controller is provided with only one or two vibrators, and therefore is limited to applying vibration stimulation to the entire surface of the skin in contact with the device. In order to vary the perception position of vibration on the contact surface, as many vibrators as the positions or a special device is required.

For example, Non Patent Literature 1 achieves presentation of vibration to each of the five fingers by wearing a vibrator for each fingertip using a glove type device.

### CITATION LIST

### Non Patent Literature

Non Patent Literature 1: Caitlyn Seim, Tanya Estes and Thad Starner, “Towards Passive Haptic Learning of Piano Songs”, IEEE World Haptics Conference, pp. 445-450, 2015.

### SUMMARY OF INVENTION

### Technical Problem

In the conventional technology, there is a problem that only one vibration source can be felt for one vibrator. If only one vibration source can be felt for one vibrator, for example, in order to transmit vibration to a plurality of positions, regions, and/or directions on the surface of the palm, the same number of vibrators is required.

The present invention has been made in view of the above circumstances, and an object thereof is to provide a vibration perception position control device, a vibration perception position control method, and a vibration perception position control program that enable a plurality of vibration sources to be felt on the palm even with one vibrator.

### Solution to Problem

In order to solve the above problem, a vibration perception position control device according to one aspect of the present invention includes a sound image localization setting unit, a vibration signal generation unit, a synchronization control unit, a guidance control unit, a sound control unit, and a vibration control unit. The sound image localization setting unit performs setting for localizing a sound image in a drive signal of a sound device on the basis of information indicating a direction of a sound source of each sound included in sound data. The vibration signal generation unit generates a vibration signal on the basis of information indicating vibration of a vibration device that applies vibration to a palm surface of a user. The synchronization control unit performs control to synchronize timings at which sound and vibration are generated. The guidance control unit controls presentation of guidance information for guiding the orientation and angle of the palm surface. The sound control unit controls the sound device according to the drive signal. The vibration control unit controls vibration of the vibration device according to the vibration signal.

### Advantageous Effects of Invention

According to one aspect of the present invention, it is possible to provide a vibration perception position control device, a vibration perception position control method, and a vibration perception position control program that enable a plurality of vibration sources to be felt on the palm even with one vibrator by presenting vibration to the palm in synchronization with sound and performing auditory presentation by controlling localization of the sound.

### BRIEF DESCRIPTION OF DRAWINGS

FIG. 1 is a diagram illustrating an example of an external appearance of a vibration perception position control device according to a first embodiment of the present invention.

FIG. 2 is a diagram illustrating an example of a way of holding the vibration perception position control device according to the first embodiment.

FIG. 3 is a diagram illustrating a hardware configuration example of the vibration perception position control device according to the first embodiment.

FIG. 4 is a functional configuration diagram of the vibration perception position control device according to the first embodiment.

FIG. 5 is a flowchart illustrating an example of a flow of the vibration perception position control processing according to the first embodiment.

FIG. 6 is a schematic diagram for describing an angle in localization information.

FIG. 7 is a diagram for describing an example of localization information and vibration parameter information.

FIG. 8 is a diagram for describing another example of localization information and vibration parameter information.

FIG. 9A is a schematic diagram for describing a pressure stimulation region and a vibration perception position in a case where the vibration perception position control device is held with less force.

FIG. 9B is a schematic diagram for describing the pressure stimulation region and the vibration perception position in a case where the vibration perception position control device is gripped firmly by the entire palm.

FIG. 10A is a schematic diagram for describing the vibration perception position in a case where the palm is oriented in the longitudinal direction.

FIG. 10B is a schematic diagram for describing the vibration perception position in a case where the palm is oriented in the lateral direction.

FIG. 11 is a diagram illustrating a hardware configuration example of a vibration perception position control device according to a second embodiment of the present invention.

FIG. 12 is a functional configuration diagram of the vibration perception position control device according to the second embodiment.

FIG. 13 is a flowchart illustrating an example of a flow of vibration perception position control processing according to the second embodiment.

FIG. 14 is a diagram illustrating a hardware configuration example in a case where the vibration perception position control device according to the second embodiment is configured by two units.

### DESCRIPTION OF EMBODIMENTS

Embodiments according to the present invention will be described below with reference to the drawings.

### First Embodiment

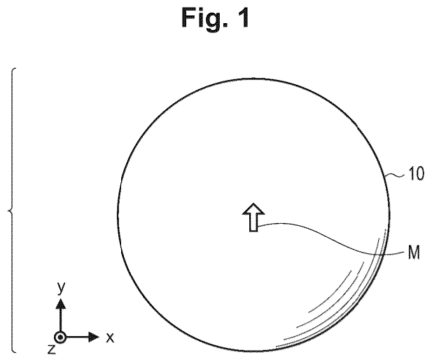

FIG. 1 is a diagram illustrating an example of an external appearance of a vibration perception position control device 10 according to a first embodiment of the present invention. The vibration perception position control device 10 is a device for causing the user to perceive vibration when the user holds the vibration perception position control device 10 on his/her palm. An xyz coordinate system for describing processing to be mentioned later is defined as illustrated in FIG. 1.

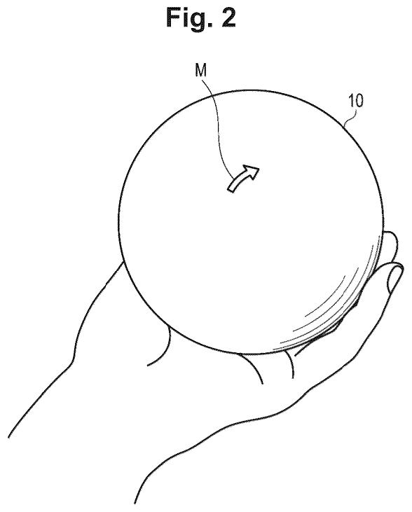

FIG. 2 is a diagram illustrating an example of a way of holding the vibration perception position control device 10. In the example of FIG. 2, the user holds the vibration perception position control device 10 on the palm of the left hand. The vibration perception position control device 10 uses an illusion of the human to cause the user to perceive that an arbitrary position on the surface of the palm is vibrating by emitting sound and vibration by processing to be described later. For example, the vibration perception position control device 10 can cause the user to perceive that a root part of the ring finger of the palm is vibrating or that a region from the root part of the thumb to the root part of the index finger is vibrating. Note that the above-described holding method is an example, and the vibration perception position control device 10 may come into contact with the palm of the user via a medium.

As illustrated in FIGS. 1 and 2, the vibration perception position control device 10 has a spherical shape. The vibration perception position control device 10 is a perfect circular sphere in the present embodiment, but may be an elliptical sphere. On the vibration perception position control device 10, a direction mark M indicating a direction when the user places and holds the vibration perception position control device 10 on the palm is written. In this embodiment, the direction mark M is an arrow, and the user is supposed to hold the vibration perception position control device 10 in a state where the direction mark M is on the upper surface and the arrow points to the fingertips.

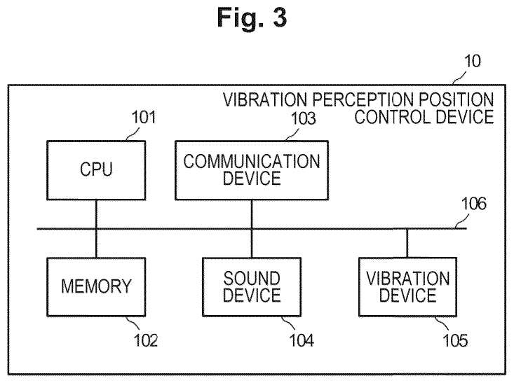

FIG. 3 is a diagram illustrating a hardware configuration example of the vibration perception position control device 10. The vibration perception position control device 10 includes a CPU 101, a memory 102, a communication device 103, a sound device 104, and a vibration device 105. The CPU 101, the memory 102, the communication device 103, the sound device 104, and the vibration device 105 are mutually connected by a bus 106.

The memory 102 is a storage using a combination of a nonvolatile memory such as a ROM and a volatile memory such as a RAM as a storage medium. The memory 102 stores programs necessary for the CPU 101 to perform various types of processing. The program includes a vibration perception position control program according to the first embodiment. The memory 102 also stores data acquired and created by the CPU 101 in the process of performing various types of processing.

The CPU 101 may be a multi-core/multi-thread CPU, and can execute a plurality of pieces of processing in parallel.

The communication device 103 is a device for transmitting and receiving signals to and from other devices. The communication may be performed in either a wired manner or a wireless manner. As the wireless method, for example, a mobile phone communication system such as 4G or 5G, a wireless LAN, a low-power wireless data communication standard such as Bluetooth (registered trademark), or the like can be used.

The sound device 104 is, for example, a speaker capable of stereo reproduction, and is a device that receives a drive signal from the CPU 101 to generate sound. Note that the vibration perception position control device 10 may omit the sound device 104. In this case, the vibration perception position control device 10 transmits a drive signal to an external sound device such as headphones, earphones, or a speaker by the communication device 103.

The vibration device 105 is a device that receives a vibration signal from the CPU 101 to generate vibration. The vibration device 105 may include one vibrator or may include a plurality of vibrators. That is, the vibration perception position control device 10 includes at least one vibrator.

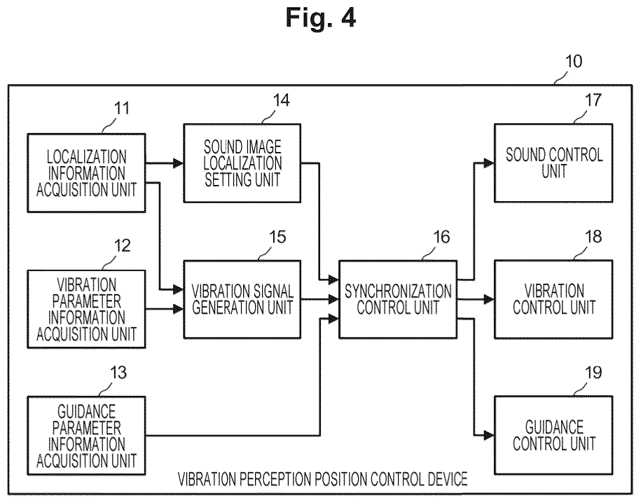

FIG. 4 is a functional configuration diagram of the vibration perception position control device 10. The vibration perception position control device 10 includes a localization information acquisition unit 11, a vibration parameter information acquisition unit 12, a guidance parameter information acquisition unit 13, a sound image localization setting unit 14, a vibration signal generation unit 15, a synchronization control unit 16, a sound control unit 17, a vibration control unit 18, and a guidance control unit 19. These processing function units are implemented by the CPU 101 and the memory 102 that are included in a computer. Specifically, each processing function unit is implemented by the CPU 101 executing the processing described in the vibration perception position control program stored in the memory 102. Note that these processing function units may be implemented in other various forms including an integrated circuit such as ASIC or FPGA.

The localization information acquisition unit 11 acquires localization information. Localization information is information indicating the direction of a sound source of each sound included in sound data. Specifically, localization information is information in which a value indicating the time at which each sound included in sound data is generated is associated with a value indicating an angle of the direction of a sound source with the front direction of the user as a reference of 0 degrees. Sound data is generated by another system on the basis of content provided by the service providing side, and localization information is generated by the other system on the basis of the sound data. Thus, localization information can be set on the service providing side. The localization information acquisition unit 11 acquires the localization information via the communication device 103 or the like.

The vibration parameter information acquisition unit 12 acquires vibration parameter information. Vibration parameter information is information indicating vibration of the vibration device 105. In a case where the vibration device 105 includes a plurality of vibrators, vibration parameter information is information indicating vibration of each vibrator. Vibration parameter information may include a frequency, a length, and the like of vibration. The vibration parameter information acquisition unit 12 acquires, for example, vibration parameter information generated by another system on the basis of content provided by the service providing side via the communication device 103 or the like. Thus, vibration parameter information, too, can be set on the service providing side.

The guidance parameter information acquisition unit 13 acquires body motion guidance parameter information. Body motion guidance parameter information is information indicating the body motion of the user. For example, body motion guidance parameter information can include an instruction of a holding force such as strongly gripping the vibration perception position control device 10 with the entire palm or lightly gripping the vibration perception position control device 10 with less force, a direction of the palm, that is, the arm, an inclination angle with respect to a z-axis direction in xyz coordinates of the palm, that is, the gravity direction, and the like. Specifically, body motion guidance parameter information may be voice data indicating instruction contents. For example, the guidance parameter information acquisition unit 13 acquires body motion guidance parameter information generated by another system on the basis of content provided by the service providing side via the communication device 103 or the like. Thus, body motion guidance parameter information, too, can be set on the service provider side.

The sound image localization setting unit 14 performs setting for localizing a sound image in a drive signal of the sound device 104 on the basis of localization information. In a case where the sound device 104 is an external device such as headphones, earphones, or the like, a relative positional relationship between the user and the vibration perception position control device 10 such as a holding posture of the vibration perception position control device 10 is assumed in advance. For example, as illustrated in FIG. 2, when the user holds the vibration perception position control device 10 with one hand with the palm facing upward, it can be defined that that the positive x-axis direction corresponds to the right direction and the positive y-axis direction corresponds to the front direction of the body. In such a holding state, for example, in a case where the angle of the sound source is θ and the x-axis direction (angle θ=90 degrees) is the direction of the sound source, it is assumed that the relative positional relationship between the user and the vibration perception position control device 10 is such that the x-axis direction is on the right side of the user. Therefore, in such a case, the sound image localization setting unit 14 performs setting so that only the earphone to be brought into contact with the right ear emits sound. Note that the setting for localizing a sound image may be a known method, and is, for example, a setting for adjusting the volume of a plurality of speakers or the like.

The vibration signal generation unit 15 generates a vibration signal on the basis of vibration parameter information. Note that in a case where the vibration device 105 includes a plurality of vibrators, a vibration signal of each vibrator is generated. The vibration signal generation unit 15 generates a vibration signal in a form of attenuating a sine wave of 200 Hz within 0.15 seconds, for example.

The synchronization control unit 16 performs control to synchronize timings at which sound and vibration are generated. Note that localization information, body motion guidance parameter information, and vibration parameter information are information designated in time series, and the time at which the sound and the vibration are generated is designated. Therefore, the synchronization control unit 16 performs control for synchronization in accordance with the designation of time indicated by the localization information, the body motion guidance parameter information, and the vibration parameter information.

The sound control unit 17 controls the sound device 104 according to the drive signal at the timing controlled by the synchronization control unit 16.

The vibration control unit 18 controls the vibration of the vibration device 105 according to the vibration signal at the timing controlled by the synchronization control unit 16.

The guidance control unit 19 controls the communication device 103 at the timing controlled by the synchronization control unit 16 to transmit a guidance audio signal to an external presentation device such as a speaker to present an instruction content by audio.

Next, a processing operation of the vibration perception position control device 10 configured as described above will be described.

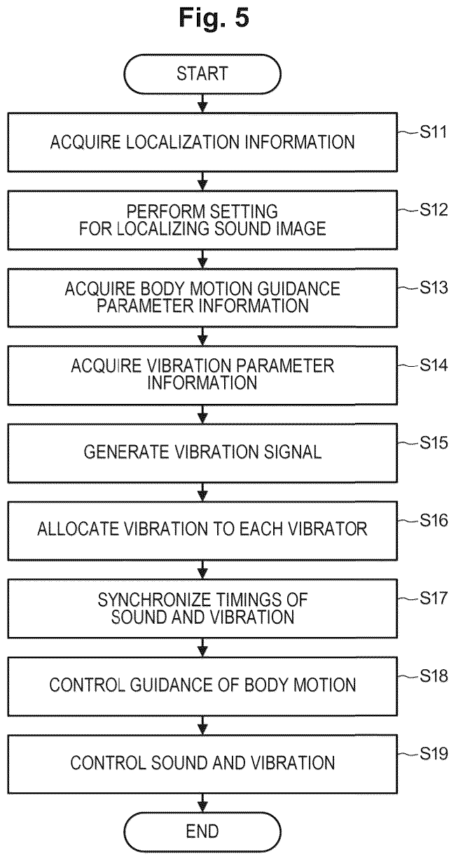

FIG. 5 is a flowchart illustrating an example of a flow of vibration perception position control processing in the vibration perception position control device 10. The vibration perception position control device 10 starts vibration perception position control processing when the power is turned ON or an instruction is received via the communication device 103 or the like. Note that the vibration perception position control device 10 may store data indicating the pitch at each time in the memory 102 in advance, or may receive the data via the communication device 103 or the like.

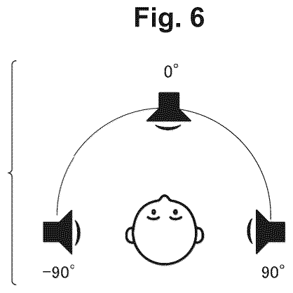

The localization information acquisition unit 11 acquires localization information via the communication device 103 or the like (step S11). Specifically, localization information is information including a combination of time and an angle θ in time series. FIG. 6 is a schematic diagram for describing an angle in localization information. As illustrated in FIG. 6, the angle θ is an angle of the sound source with the front direction of the user as a reference of 0 degrees. The user's right ear direction is θ=90 degrees, and the user's left ear direction is θ=−90 degrees. An example of localization information is ((t1, −90), (t2, 0), (t3, 90)). In this case, the sound device 104 emits a sound having θ=−90 degrees as a sound source at time t1, emits a sound having θ=0 degrees as a sound source at time t2, and emits a sound having θ=90 degrees as a sound source at time t3.

Next, the sound image localization setting unit 14 performs setting for localizing a sound image on the basis of localization information (step S12).

Subsequently, the guidance parameter information acquisition unit 13 acquires body motion guidance parameter information via the communication device 103 or the like (step S13). Specifically, body motion guidance parameter information is information including a combination of time and voice data indicating instruction contents related to the body motion of the user in time series.

Next, the vibration parameter information acquisition unit 12 acquires vibration parameter information via the communication device 103 or the like (step S14). Specifically, vibration parameter information is information including a combination of time and an identifier (hereinafter referred to as vibrator ID) indicating a vibrator in time series. In a case where there is one vibrator, the vibrator ID may be omitted. An example of vibration parameter information is ((t1, v2), (t2, v1, v2)). Here, v1 and v2 are examples of the vibrator ID. In this case, in the vibration device 105, a vibrator v2 vibrates at time t1, and a vibrator v1 and the vibrator v2 vibrate at time t2.

Subsequently, the vibration signal generation unit 15 generates a vibration signal on the basis of vibration parameter information (step S15).

Here, in a case where the vibration device 105 includes a plurality of vibrators, the vibration signal generation unit 15 allocates vibration to each of the vibrators (step S16). That is, the vibration signal generation unit 15 generates a vibration signal for each vibrator. Note that in a case where the vibration device 105 includes one vibrator, the vibration signal generation unit 15 may omit the processing of step S16.

Next, the synchronization control unit 16 synchronizes the timings of sound and vibration (step S17). Specifically, the synchronization control unit 16 performs synchronization control in accordance with the designation of the time indicated in the localization information, the body motion guidance parameter information, and the vibration parameter information.

Subsequently, the guidance control unit 19 controls guidance of the body motion of the user at the timing controlled by the synchronization control unit 16 (step S18). Specifically, the guidance control unit 19 controls the communication device 103 at the timing controlled by the synchronization control unit 16 to transmit a guidance audio signal to an external presentation device such as a speaker and cause the presentation device to output sound that guides the body motion of the user.

Next, the sound control unit 17 and the vibration control unit 18 control sound and vibration at the timing controlled by the synchronization control unit 16 (step S19). Specifically, the sound control unit 17 controls the sound device 104 according to the drive signal at the timing controlled by the synchronization control unit 16. In addition, the vibration control unit 18 controls vibration of the vibration device 105 according to the vibration signal at the timing controlled by the synchronization control unit 16.

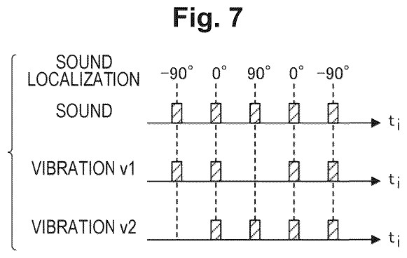

FIG. 7 is a diagram for describing an example of localization information and vibration parameter information. Localization information corresponding to FIG. 7 is, for example, ((t1, −90), (t2, 0), (t3, 90), (t4, 0), (t5, −90)). In addition, vibration parameter information is, for example, ((t1, v1), (t2, v1, v2), (t3, v2), (t4, v1, v2), (t5, v1, v2)).

Based on the localization information and the vibration parameter information described above, at time t1, the sound device 104 emits sound so that it feels as though the sound source is in a direction of −90 degrees, the vibrator v1 included in the vibration device 105 vibrates, and the vibrator v2 included in the vibration device 105 does not vibrate. In addition, at time t2, the sound device 104 emits sound so that it feels as though the sound source is in a direction of 0 degrees, and the vibrator v1 and the vibrator v2 included in the vibration device 105 vibrate. At time t3, the sound device 104 emits sound so that it feels as though the sound source is in a direction of 90 degrees, the vibrator v1 included in the vibration device 105 does not vibrate, and the vibrator v2 included in the vibration device 105 vibrates. At time t4, the sound device 104 emits sound so that it feels as though the sound source is in a direction of 0 degrees, and the vibrator v1 and the vibrator v2 included in the vibration device 105 vibrate. Then, at time t5, the sound device 104 emits sound so that it feels as though the sound source is in a direction of −90 degrees, and the vibrator v1 and the vibrator v2 included in the vibration device 105 vibrate.

Note that some of the various types of information described above may be in a format conforming to the musical instrument digital interface (MIDI) standard.

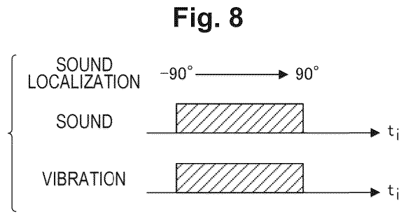

FIG. 8 is a diagram for describing another example of localization information and vibration parameter information. The sound source and the vibration presented in synchronization are not limited to discrete presentation as illustrated in FIG. 7, and may be continuous presentation as illustrated in FIG. 8.

When the sound and the vibration are synchronized as described above, even if there is only one vibrator included in the vibration device 105, it is possible to cause the user to have an illusion that a part corresponding to the direction of each sound source vibrates in the vibration perception position control device 10.

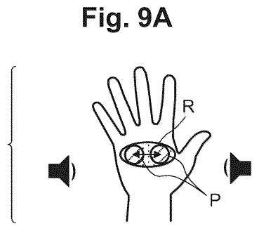

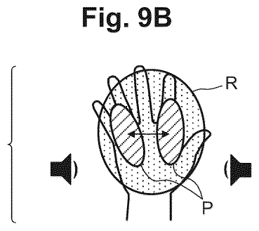

FIG. 9A is a schematic diagram for describing a pressure stimulation region R and a vibration perception position P in a case where the vibration perception position control device 10 is held with less force. In addition, FIG. 9B is a schematic diagram for describing the pressure stimulation region R and the vibration perception position P in a case where the vibration perception position control device 10 is gripped firmly by the entire palm. The pressure stimulation region R is a region where the magnitude of the pressure stimulation is equal to or greater than a certain value. In a case where the user holds the vibration perception position control device 10 with less force as illustrated in FIG. 9A, the pressure stimulation region R depends on gravity, that is, depends on the inclination angle of the palm with respect to the gravity direction. Hereinafter, the inclination angle of the palm with respect to the gravity direction is referred to as a “palm angle”. In a case where the user grips the vibration perception position control device 10 firmly by the entire palm as illustrated in FIG. 9B, the pressure stimulation region R extends over substantially the entire palm. In this case, the pressure stimulation region R hardly depends on the palm angle.

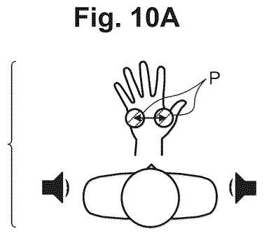

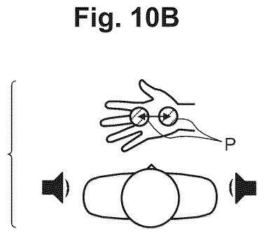

FIG. 10A is a schematic diagram for describing the vibration perception position P in a case where the palm is oriented in the longitudinal direction. Meanwhile, FIG. 10B is a schematic diagram for describing the vibration perception position P in a case where the palm is oriented in the lateral direction. The vibration perception position P is a position at which the user feels vibration. The vibration perception position P varies depending on the sound emitted by the sound device 104, that is, the direction of the sound source. In a state where the user holds the vibration perception position control device 10 with the palm oriented in the longitudinal direction, that is, with the palm oriented so that the fingertips face the front direction of the user as illustrated in FIG. 10A, the vibration perception position P can be varied in the left and right directions of the palm by varying the direction of the sound source as indicated by a double-headed arrow in FIG. 10A as well as FIGS. 9A and 9B. For example, when the sound device 104 emits sound so that it feels as though the sound source is in a direction of −90 degrees and vibrates the vibrator included in the vibration device 105, the user can be caused to have an illusion that the vibration is on the left side of the palm. Meanwhile, when the sound device 104 emits sound so that it feels as though the sound source is in a direction of 90 degrees and vibrates the vibrator included in the vibration device 105, the user can be caused to have an illusion that the vibration is on the right side of the palm. Thus, it is possible to cause the user to have an illusion that a part corresponding to the direction of the sound source vibrates even though the same vibrator generates the same vibration.

In addition, in a state where the user holds the vibration perception position control device 10 with the palm oriented in the lateral direction, that is, with the palm oriented so that the fingertips face the left of the user as illustrated in FIG. 10B, the vibration perception position P can be varied in the upper and lower directions of the palm (fingertip/wrist direction) by varying the direction of the sound source as indicated by a double-headed arrow in FIG. 10B. For example, when the sound device 104 emits sound so that it feels as though the sound source is in a direction of −90 degrees and vibrates the vibrator included in the vibration device 105, the user can be caused to have an illusion that the vibration is on the upper side of the palm (base of the finger). In addition, when the sound device 104 emits sound so that it feels as though the sound source is in a direction of 90 degrees and vibrates the vibrator included in the vibration device 105, the user can be caused to have an illusion that the vibration is on the lower side of the palm (near the wrist of the palm). Thus, even if the orientation of the palm is changed, it is possible to cause the user to feel as if a part corresponding to the direction of the sound source vibrates on a vector extension line connecting two points of both ears.

Therefore, by changing the way of gripping the vibration perception position control device 10 or the angle and orientation of the palm, it is possible to make the user perceive vibration in various positions and various size ranges of the palm even though the same vibration is generated by the same vibrator. Therefore, in addition to presenting the sound source and the vibration in synchronization, the body motion of the user indicating the way of gripping the vibration perception position control device 10 and the angle and orientation of the palm is guided, whereby the vibration perceived by the user can be controlled.

As described above in detail, the vibration perception position control device 10 according to the first embodiment of the present invention uses the effect of the cross-modal perception, which is a phenomenon in which perception in tactile sensation changes as tactile information is complemented by auditory information that is simultaneously presented. The vibration perception position control device 10 presents vibration to the palm in synchronization with sound in accordance with localization information and vibration parameter information provided by the system side on the basis of content provided by the service providing side, and controls localization of the sound to perform auditory presentation. As a result, the vibration perception position P can be varied on a vector extension line connecting both ears on the surface of the palm in contact with the vibration perception position control device 10. The vibration perception position control device 10 can vary the perception position of vibration in the pressure stimulation region R where the pressure stimulation depending on the way of gripping the vibration perception position control device 10 with the palm is equal to or more than a certain level. Then, the vibration perception position control device 10 controls the varying direction and the varying region range of the vibration perception position P by guiding the way of gripping with the palm, the direction, the angle, and the like according to guidance parameter information provided by the system side on the basis of the content provided by the service providing side.

In addition, the sound image localization setting unit 14 performs setting for localizing a sound image so that it is perceived that the vibration perception position P varies on a vector extension line connecting both ears of the user on the palm surface in contact with the vibration device 105. Specifically, the sound image localization setting unit 14 performs setting for localizing a sound image in the drive signal of the sound device 104 so that a direction from the vibration device 105 toward a position on the palm surface where vibration is desired to be perceived is the direction of the sound source. This makes the user feel as though the position on the palm surface is vibrating.

In addition, the guidance control unit 19 guides the orientation and angle of the palm surface in contact with the vibration device 105 such that the vibration perception position P is perceived as varying in the pressure stimulation region R, which is a region where the pressure stimulation on the palm surface in contact with the vibration device 105 is equal to or greater than a certain value. Thus, the vibration perception position P can be controlled.

Specifically, the guidance control unit 19 controls the varying direction or the varying direction and the varying region range of the vibration perception position P by guiding the orientation or the orientation and angle of the palm surface in contact with the vibration device 105. Thus, by performing guidance for causing the user to vary the orientation or the orientation and angle of the palm surface, it is possible to change the varying direction or the varying direction and the varying region range of the vibration perception position P.

### Second Embodiment

Next, a second embodiment of the present invention will be described. In the following description, the same parts as those in the first embodiment will be denoted by the same reference signs as those in the first embodiment, and the description thereof will be omitted.

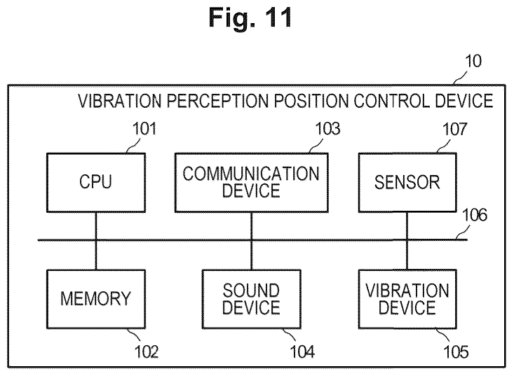

FIG. 11 is a diagram illustrating a hardware configuration example of a vibration perception position control device 10 according to the second embodiment of the present invention. In the second embodiment, a sensor 107 is further included in the hardware configuration of the vibration perception position control device 10 according to the first embodiment. The sensor 107 is, for example, an acceleration sensor, a gyro sensor that detects angular velocity, or the like.

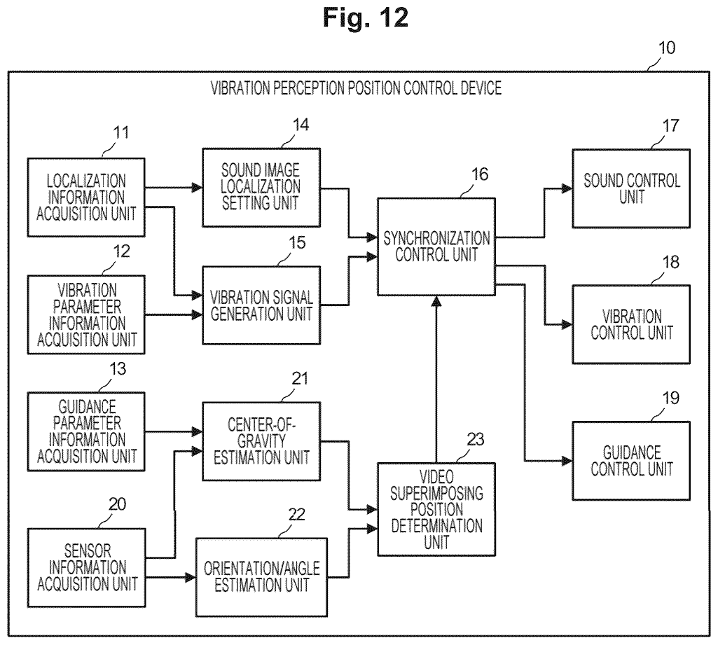

FIG. 12 is a functional configuration diagram of the vibration perception position control device 10 according to the second embodiment. In the second embodiment, the functional configuration of the vibration perception position control device 10 according to the first embodiment further includes a sensor information acquisition unit 20, a center-of-gravity estimation unit 21, an orientation/angle estimation unit 22, and a video superimposing position determination unit 23.

The sensor information acquisition unit 20 acquires sensor information that is detection data of the sensor 107.

The center-of-gravity estimation unit 21 estimates the center of gravity of the palm, which is a body part in contact with the vibration perception position control device 10, on the basis of the sensor information acquired by the sensor information acquisition unit 20. At this time, the center-of-gravity estimation unit 21 can estimate the center of gravity using guidance parameter information acquired by a guidance parameter information acquisition unit 13. As described in the first embodiment, since guidance parameter information is information indicating the instruction content of the body motion to the user, it is possible to know how the palm has moved so far and how the palm will move from now on. That is, the orientation and angle of the palm at the time when the sensor information is acquired can be assumed on the basis of the guidance parameter information. Therefore, it is possible to estimate where the center of gravity of the palm at the current time is on the basis of the assumed orientation and angle of the palm and the actual movement of the palm indicated by the sensor information.

The orientation/angle estimation unit 22 estimates the orientation and angle of the palm, which is the target part, on the basis of the sensor information acquired by the sensor information acquisition unit 20.

On the basis of the estimation result of the center of gravity by the center-of-gravity estimation unit 21 and the estimation result of the orientation and angle of the palm by the orientation/angle estimation unit 22, the video superimposing position determination unit 23 calculates the superimposing position at which a video for guiding the body motion of the user is to be superimposed and displayed on the palm, which is a body part, or in a virtual space. Guidance parameter information that is information indicating an instruction content of a body motion to the user acquired by the guidance parameter information acquisition unit 13 can be guidance video content including the instruction content formed by sound and video.

Therefore, in the second embodiment, a synchronization control unit 16 performs control to synchronize the timing to generate sound and vibration with the timing to generate video. That is, the synchronization control unit 16 controls the timing of a video drive signal on the basis of the superimposing position information calculated by the video superimposing position determination unit 23. A guidance control unit 19 controls a communication device 103 at the timing controlled by the synchronization control unit 16 to transmit a video content signal to a presentation device such as a head mounted display for augmented reality (AR) or virtual reality (VR) to present a guidance video content indicating an instruction content by video or sound. That is, the presentation device superimposes and displays a video on the palm of the user by AR, or superimposes and displays a video at an arbitrary position in a virtual space by VR.

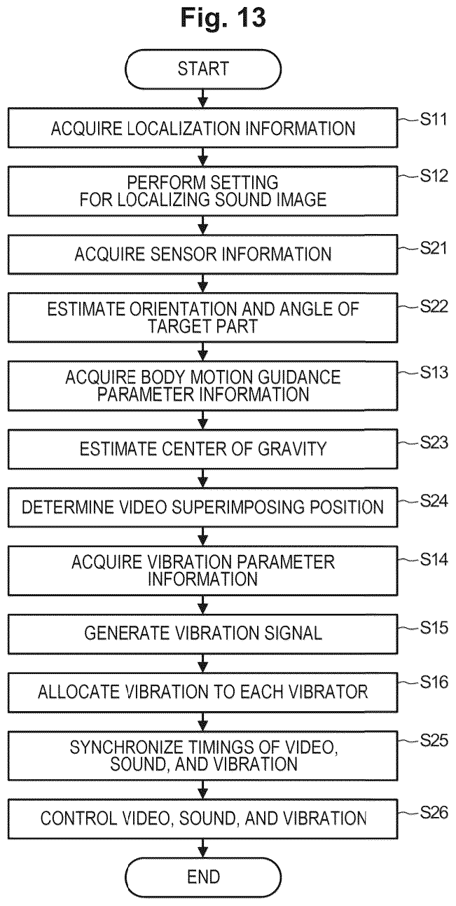

FIG. 13 is a flowchart illustrating an example of a flow of vibration perception position control processing in the vibration perception position control device 10 according to the second embodiment. Similarly to the first embodiment, a localization information acquisition unit 11 acquires localization information via the communication device 103 or the like (step S11). Next, the sound image localization setting unit 14 performs setting for localizing a sound image on the basis of localization information (step S12).

Subsequently, the sensor information acquisition unit 20 acquires sensor information from the sensor 107 (step S21).

Next, the orientation/angle estimation unit 22 estimates the current orientation and angle of the palm on the basis of the sensor information acquired by the sensor information acquisition unit 20 (step S22).

Subsequently, as in the first embodiment, the guidance parameter information acquisition unit 13 acquires body motion guidance parameter information via the communication device 103 or the like (step S13).

Next, the center-of-gravity estimation unit 21 estimates the center of gravity of the palm, which is a body part with which the vibration perception position control device 10 is in contact, on the basis of the guidance parameter information acquired by the guidance parameter information acquisition unit 13 and the sensor information acquired by the sensor information acquisition unit 20 (step S23).

Subsequently, the video superimposing position determination unit 23 determines the video superimposing position on which a video of a guidance video content is to be superimposed on the basis of the center of gravity of the palm estimated by the center-of-gravity estimation unit 21 and the orientation and angle of the palm estimated by the orientation/angle estimation unit 22 (step S24).

Next, the vibration parameter information acquisition unit 12 acquires vibration parameter information via the communication device 103 or the like (step S14). Subsequently, the vibration signal generation unit 15 generates a vibration signal on the basis of vibration parameter information (step S15). Here, in a case where the vibration device 105 includes a plurality of vibrators, the vibration signal generation unit 15 allocates vibration to each of the vibrators (step S16).

Next, a synchronization control unit 16 synchronizes the timings of video, sound, and vibration (step S25). Specifically, the synchronization control unit 16 performs control to synchronize in accordance with the designation of the time indicated in the localization information and the vibration parameter information, the time indicated in the guidance parameter information, and the video superimposing position determined by the video superimposing position determination unit 23.

Subsequently, a sound control unit 17, a vibration control unit 18, and a guidance control unit 19 control the video, the sound, and the vibration at the timing controlled by the synchronization control unit 16 (step S26). Specifically, the sound control unit 17 controls the sound device 104 according to the drive signal at the timing controlled by the synchronization control unit 16. In addition, the vibration control unit 18 controls vibration of the vibration device 105 according to the vibration signal at the timing controlled by the synchronization control unit 16. Moreover, a guidance control unit 19 controls the communication device 103 at the timing controlled by the synchronization control unit 16 to transmit a video content signal to an external presentation device and cause the presentation device to output a guidance video content for guiding a body motion of the user.

As described above in detail, the vibration perception position control device 10 according to the second embodiment of the present invention includes the orientation/angle estimation unit 22 that estimates the orientation and angle of the palm surface, the center-of-gravity estimation unit 21 that estimates the center of gravity of the contact surface of the palm surface with the vibration device 105, and the video superimposing position determination unit 23, the synchronization control unit 16, and the guidance control unit 19 that serve as a superimposition unit that superimposes an image content on the user's palm or an arbitrary position in a virtual space on the basis of the estimation result of the orientation and angle of the palm surface and the estimation result of the center of gravity. Therefore, the body motion of the user can be guided by video in addition to sound.

### OTHER EMBODIMENTS

Note that the present invention is not limited to the above embodiments.

For example, the vibration perception position control device 10 does not have to be a casing having a spherical shape as illustrated in FIG. 1, and may be a quadrangular prism. Specifically, the vibration perception position control device 10 may be, for example, a mobile terminal such as a smartphone.

When the vibration perception position control device 10 is a mobile terminal such as a smartphone, each processing described above may be defined in an application program installed in the smartphone or the like. That is, in the first and second embodiments, the vibration perception position control device 10 acquires the guidance parameter information and the like provided by the system side on the basis of the content provided by the service providing side via the communication device, but the vibration perception position control device 10 can generate such guidance parameter information and the like on the basis of a content. That is, the vibration perception position control device 10 may be a system that reproduces content.

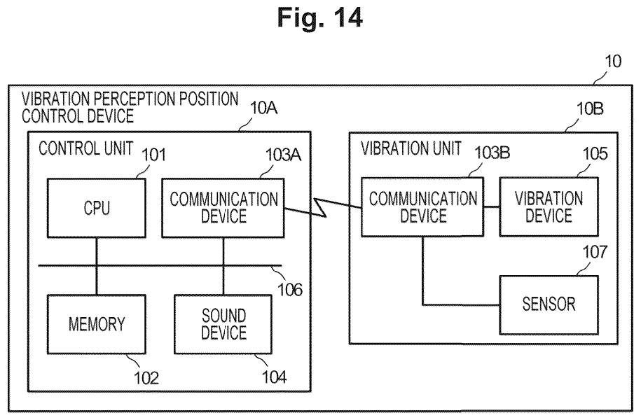

In addition, the vibration perception position control device 10 may dispersedly accommodate the units forming the vibration perception position control device 10 in a plurality of casings. FIG. 14 is a diagram illustrating a hardware configuration example in a case where the vibration perception position control device 10 according to the second embodiment is configured by two units of a control unit 10A and a vibration unit 10B. The control unit 10A includes a CPU 101, a memory 102, a communication device 103A, and a sound device 104, and the vibration unit 10B includes a communication device 103B, a vibration device 105, and a sensor 107. The vibration unit 10B can be a casing having a spherical shape as illustrated in FIG. 1. The sound device 104 may also be a separate unit. The vibration perception position control device 10 according to the first embodiment can similarly be dispersed in a plurality of units.

In addition, the flow of the processing described with reference to each flowchart of FIGS. 5 and 13 is not limited to the described procedure, and the order of some steps may be replaced, some steps may be performed simultaneously in parallel, or the processing content of some steps may be modified.

In addition, the vibration signal generation unit 15 may generate a vibration signal so that the intensity of vibration corresponding to each sound increases and decreases repeatedly. As a result, it is possible to make the user feel that something changes for each sound, and thus, it is easy to cause an illusion that a part corresponding to the direction of each sound source is vibrating.

In addition, the method described in each embodiment can be stored as a processing program (software means) that can be executed by a computer in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) or can be distributed by being transmitted through a communication medium. Note that the program stored on the medium side also includes a setting program for configuring, in the computer, the software means (including not only execution program but also table and data structure) to be executed by the computer. The computer that implements the present device executes the above-described processing by reading the programs recorded in the recording medium, constructing the software means by a setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

In short, the present invention is not limited to the above embodiments without any change, but can be embodied by modifying the constituent elements without departing from the gist of the invention at the implementation stage. In addition, various inventions can be formed by appropriately combining a plurality of the constituent elements disclosed in the above embodiments. For example, some of the constituent elements described in the embodiments may be omitted. Moreover, constituent elements in different embodiments may be appropriately combined.

### REFERENCE SIGNS LIST

10 Vibration perception position control device
10A Control unit
10B Vibration unit
11 Localization information acquisition unit
12 Vibration parameter information acquisition unit
13 Guidance parameter information acquisition unit
14 Sound image localization setting unit
15 Vibration signal generation unit
16 Synchronization control unit
17 Sound control unit
18 Vibration control unit
19 Guidance control unit
20 Sensor information acquisition unit
21 Center-of-gravity estimation unit
22 Orientation/angle estimation unit
23 Video superimposing position determination unit
101 CPU
102 Memory
103, 103A, 103B Communication device
104 Sound device
105 Vibration device
106 Bus
107 Sensor
M Direction mark
P Vibration perception position
R Pressure stimulation region

1. A vibration perception position control device comprising:
sound image localization setting circuitry that performs setting for localizing a sound image in a drive signal of a sound device on the basis of information indicating a direction of a sound source of each sound included in sound data;
vibration signal generation circuitry that generates a vibration signal on the basis of information indicating vibration of a vibrator vibration device that applies vibration to a palm surface of a user;
synchronization control circuitry that performs control to synchronize timings at which sound and vibration are generated;
guidance control circuitry that controls presentation of guidance information for guiding an orientation and an angle of the palm surface;
sound control circuitry that controls the sound device according to the drive signal; and
vibration control circuitry that controls vibration of the vibrator according to the vibration signal.

2. The vibration perception position control device according to claim 1, wherein:
the sound image localization setting circuitry performs setting for localizing the sound image so that it is perceived that a perception position of the vibration varies on a vector extension line connecting both ears of the user on the palm surface in contact with the vibrator.

3. The vibration perception position control device according to claim 1, wherein:
the guidance control circuitry guides the orientation and the angle of the palm surface in contact with the vibrator such that a perception position of the vibration is perceived as varying in a region where a pressure stimulation on the palm surface in contact with the vibrator is equal to or greater than a certain value.

4. The vibration perception position control device according to claim 2, wherein;
the guidance control circuitry controls a varying direction and a varying region range of the perception position of the vibration by guiding an orientation and an angle of the palm surface in contact with the vibrator.

5. The vibration perception position control device according to claim 2, wherein:
the guidance control circuitry controls a varying direction of the perception position of the vibration by guiding an orientation of the palm surface in contact with the vibrator.

6. The vibration perception position control device according to claim 1, further comprising:
an orientation/angle estimation circuitry that estimates an orientation and an angle of the palm surface;
a center-of-gravity estimation circuitry that estimates a center of gravity of a contact surface of the palm surface with the vibrator; and
a superimposition circuitry that superimposes video content on a palm of the user or an arbitrary position in a virtual space on the basis of an estimation result of the orientation and the angle of the palm surface and an estimation result of the center of gravity.

7. A vibration perception position control method, comprising:
performing setting for localizing a sound image in a drive signal of a sound device on the basis of information indicating a direction of a sound source of each sound included in sound data;
generating a vibration signal on the basis of information indicating vibration of a vibration device that applies vibration to a palm surface of a user;
performing control to synchronize timings at which sound and vibration are generated;
controlling presentation of guidance information for guiding an orientation and an angle of the palm surface by a presentation device;
controlling the sound device according to the drive signal; and
controlling vibration of the vibration device according to the vibration signal.

8. A non-transitory computer readable medium storing a vibration perception position control program for causing a computer to execute the method of claim 7.
